(19) United States
(12) Patent Application Publication
(10) Pub. No.: US 2013/0311342 A1
(43) Pub. Date: Nov. 21, 2013

(54) SYSTEM AND METHOD FOR OPTIMIZING DEBT COLLECTION IN BANKRUPTCY

(71) Applicant: John Dale McMickle, Chevy Chase, MD (US)

(72) Inventor: John Dale McMickle, Chevy Chase, MD (US)

(21) Appl. No.: 13/474,254

(22) Filed: May 17, 2012

(51) Int. Cl. G06Q 40/00

(52) U.S. Cl. 705/35

(57) ABSTRACT

A system and method for optimizing debt collection is described. The method includes establishing acceptable threshold amounts, receiving bankruptcy filing information via a computing network, determining if income and expense amounts exceed the acceptable threshold amounts, receiving credit reporting and transactional data from a financial network database, analyzing the credit reporting and transactional data to identify a pattern of consumption, identifying a geographic region associated with the bankruptcy filing information, receiving information regarding licensed attorneys from an attorney database, receiving a selection of an attorney, and transmitting bankruptcy filing information, the pattern of consumption, credit reporting data, and transactional data to the selected attorney.

### BACKGROUND

The present disclosure relates in general to debt collection, and in particular to a system and method for debt collection in a bankruptcy by a creditor or assignee of a creditor.

### BRIEF DESCRIPTION OF THE DRAWINGS

FIG. 1 is a diagrammatic illustration of a system according to an exemplary embodiment.

FIG. 2 is a diagrammatic illustration of a module of FIG. 1, according to an exemplary embodiment.

FIG. 3 is a flow chart illustration of a method of operating the system of FIG. 1, according to an exemplary embodiment.

FIG. 4 is a diagrammatic illustration of a node for implementing one or more exemplary embodiments of the present disclosure, according to an exemplary embodiment.

### DETAILED DESCRIPTION

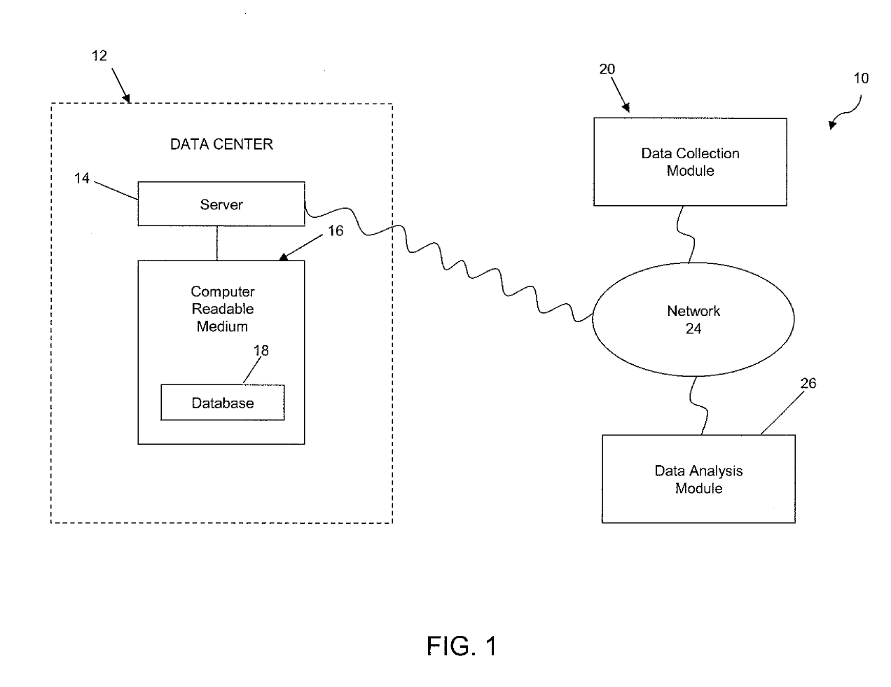

In an exemplary embodiment, as illustrated in FIG. 1, a system is generally referred to by the reference numeral 10 and includes a data center 12 including a server 14 and a computer readable medium 16 operably coupled thereto. Instructions accessible to, and executable by, the server 14 are stored in the computer readable medium 16. A database 18 is also stored in the computer readable medium 16. The system 10 further includes a data collection module 20, which is used to collect data from various databases, in a manner to be described below. The data collection module 20 is operably coupled to, and in two-way communication with, the server 14 via a network 24. A data analysis module 26 is operably coupled via the network 24 to each of the data collection module 20 and the server 14, and is used to analyze the data collected by the module 20, in a manner to be described below.

In an exemplary embodiment, the server 14 is a web application server. In an exemplary embodiment, the data center 12 is, includes, or is at least a part of, a web-based program, an Intranet-based program, and/or any combination thereof. In an exemplary embodiment, the data center 12 and/or one or more components thereof, the computer readable medium 16 and/or content stored therein, the database 18 and/or content stored therein, and/or any combination thereof, are part of, and/or are distributed throughout, the system 10 and/or one or more of the components thereof, including, for example, one or more of the modules 20 and 26. In an exemplary embodiment, the network 24 includes the Internet, one or more local area networks, one or more wide area networks, one or more cellular networks, one or more wireless networks, one or more voice networks, one or more data networks, one or more communication systems, and/or any combination thereof. In several exemplary embodiments, the respective quantities of one or more of the components and/or parts of the system 10, such as, for example, the respective quantities of the data center 12, the server 14, the computer readable medium 16, the database 18, the module 20 and the module 26 are increased, decreased or otherwise varied.

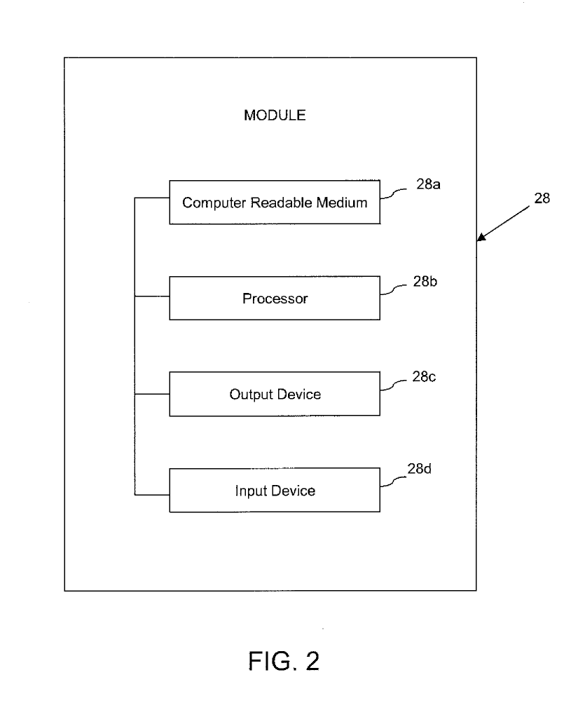

In an exemplary embodiment, as shown in FIG. 2, a module 28 includes a computer readable medium 28a, a processor 28b, an output device 28c, and an input device 28d. In an exemplary embodiment, instructions accessible to, and executable by, the processor 28b are stored in the computer readable medium 28a. In an exemplary embodiment, spreadsheet and/or web browser software is stored in the computer readable medium 28a. In an exemplary embodiment, the output device 28c includes a graphical display, which, in several exemplary embodiments, is in the form of, or includes, one or more digital displays, one or more liquid crystal displays, one or more cathode ray tube monitors, and/or any combination thereof. In an exemplary embodiment, the output device 28c includes a graphical display, a printer, a plotter, and/or any combination thereof. In an exemplary embodiment, the input device 28d includes a touch screen, which, in several exemplary embodiments, is, includes, or is at least a part of the output device 28c. In an exemplary embodiment, instead of, or in addition to a touch screen, the input device 28d includes one or more keyboards, one or more PIN pads, one or more scanners, one or more card readers, and/or any combination thereof.

In an exemplary embodiment, the data collection module 20 is substantially identical to the data analysis module 26 and are separate modules 28. In several exemplary embodiments, one of the modules 20 and 26 is omitted in favor of the other of the modules 20 and 26. In several exemplary embodiments, the module 20 is combined in whole or in part with the module 26.

In an exemplary embodiment, the module 28 is, includes, or is at least a part of, the data center 12, the server 14, the computer readable medium 16, the database 18, and/or any combination thereof. In several exemplary embodiments, the module 28 is a thin client and the server 14 controls at least a portion of the operation of the module 28. In several exemplary embodiments, the module 28 is a thick client. In several exemplary embodiments, the module 28 functions as both a thin client and a thick client. In several exemplary embodiments, the module 28 is, or includes, a telephone, a personal computer, a portable computer, a personal digital assistant, a cellular telephone, other types of telecommunications devices, other types of computing devices, and/or any combination thereof. In several exemplary embodiments, the module 28 includes a plurality of modules. In several exemplary embodiments, the module 28 is, or at least includes, the data center 12.

In several exemplary embodiments, the platforms of the server 14 and the modules 20 and 26 are identical, different, or vary with respect to equipment, peripherals, hardware architecture and/or specifications, software architecture and/or specifications, and/or any combination thereof.

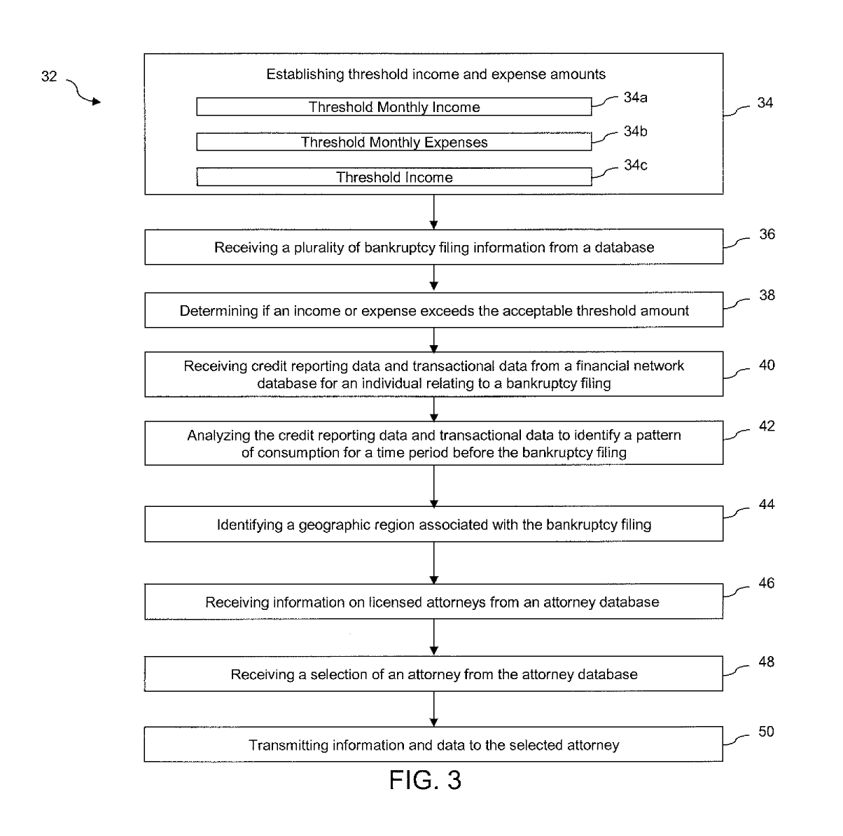

In an exemplary embodiment, as illustrated in FIG. 3 with continuing reference to FIGS. 1 and 2, a method of operating the system 10 is generally referred to by the reference numeral 32 and, in several exemplary embodiments, the method 32 is implemented in whole or in part by the data center 12, the module 20, the module 26, and/or any combination thereof.

As shown in FIG. 3, the method 32 includes establishing acceptable threshold income and expense amounts, including a threshold monthly income amount 34a, threshold monthly expense amount 34b, and threshold income amount 34c in step 34, receiving a plurality of bankruptcy filing information from a database in step 36, determining for each of the plurality of bankruptcy filing information, if an income or expense amount exceeds the acceptable threshold amount at step 38, for each of the plurality of bankruptcy filing information in which the income or expense amount exceeds the acceptable threshold amount, receiving credit reporting data and transactional data from a financial network database for an individual relating to one of the plurality of bankruptcy filing information at step 40, analyzing the credit reporting data and transactional data to identify a pattern of consumption for a time period before the filing date associated with the one of the plurality of bankruptcy filing information at step 42, for each of the plurality of bankruptcy filing information in which the identified pattern of consumption exceeds a predefined threshold, identifying a geographic region associated with the bankruptcy filing information at step 44, receiving information on licensed attorneys with from an attorney database wherein the information is associated with the geographic region at step 46, receiving a selection of an attorney from the attorney database at step 48, and transmitting the bankruptcy filing information, the pattern of consumption, and credit reporting data to the selected attorney at step 50.

In an exemplary embodiment, to establish acceptable threshold income and expense amounts in step 34, the U.S. code and bankruptcy petition forms are employed. For example, the threshold monthly income can be set at $6000 based on 11 U.S.C. §101(10A), the threshold monthly expenses can be set at $4000 based on Schedule J of a bankruptcy petition, and the threshold income can be set at $4000 based on Schedule I of a bankruptcy petition.

In an exemplary embodiment, to receive a plurality of bankruptcy filing information from a database in step 36, an electronic service that monitors bankruptcy filings in all judicial districts, such as PACER, transmits the filings to the data collection module 20 via the network 24 on a daily basis. In one embodiment, the bankruptcy filing information includes Chapter 13 bankruptcy filings. The bankruptcy filing information preferably includes identifying information (e.g., name, address, Social Security number, date of birth, employment information, etc.) of an individual filing for bankruptcy, the personal and real property owned by the individual, the individual's creditors, the individual's current monthly income, and the individual's current expenditures, including monthly expenses. In another embodiment, once the data collection module 20 receives a portion of identifying information, the module 20 cross references the portion with another database to determine additional identifying information. For example, if a name and a portion of a Social Security number is available, the module 20 can use the name and partial Social Security number to obtain the full Social Security number by cross referencing another database.

In an exemplary embodiment, to determine for each of the plurality of bankruptcy filing information, if an income or expense exceeds the acceptable threshold amount at step 38, the data analysis module 26 communicates with the data collection module 20 through the network 24 to obtain the bankruptcy filing information and processes the information. The data analysis module 26 compares the income and expense amount information in the collected filings to the established threshold amounts for income and expense. In an exemplary embodiment, the data analysis module 26 determines if (1) the current monthly income exceeds $6000, (2) the monthly expenses exceed $4000, and (3) the income exceeds $4000. If the data analysis module 26 determines that one of the plurality of bankruptcy filing information satisfies at least one of these criteria, the method 32 proceeds to step 40.

In an exemplary embodiment, for each of the plurality of bankruptcy filing information in which the income or expense amount exceeds the acceptable threshold amount, to receive credit reporting data and transactional data from a financial network database for an individual relating to one of the plurality of bankruptcy filing information at step 40, the data collection module 20 accesses a financial network database through the network 24 to obtain credit reporting data and transactional data from a financial network provider. In one embodiment, the financial network database is provided by debt collection data services such as Equifax, Inc. or Experian Inc. The credit reporting data and transactional data preferably includes identifying information of an individual (e.g., name, address, Social Security number, date of birth, employment information, etc.), credit accounts of the individual (including loan amounts, credit limit, account balance, and payment history), public record information, information on overdue debt from collection agencies, purchases, and cash advances. In an exemplary embodiment, the credit reporting and transactional data includes size and timing of purchases and nature of products or services purchased.

In an exemplary embodiment, to analyze the credit reporting data and transactional data to identify a pattern of consumption for a time period before the filing date associated with the one of the plurality of bankruptcy filing information at step 42, the data analysis module 26 communicates with the data collection module 20 through the network 24 and obtains the credit reporting data and transactional data from the data collection module 20. In one embodiment, the data analysis module 26 analyzes the credit reporting data and transactional data to determine if the data shows an irregular or atypical pattern of consumption one year before the filing for bankruptcy. The size of a purchase, timing of the purchase, and the nature of the products or services purchases are indicia relevant to identifying the pattern. For example, the data analysis module 26 identifies: (1) a transaction or cash advance that occurred within one year prior to the date of bankruptcy filing; (2) transactions exceeding $1000; (3) an irregular transaction given the transaction history; (4) cash advances exceeding $500; and/or (5) transactions occurring at a retail establishment or Internet site that specializes in non-essential luxury items or consumer electronics such as: Neiman Marcus®, Tiffany & Co.®, Saks Fifth Avenue®, Barneys New York™, Bergdorf Goodman®, Coach™, Nordstrom®, Gucci®, and Best Buy®. The data analysis module 26 examines this data to determine whether the purchases and cash advances form part of a regular pattern of consumption (individual normally takes large cash advances on luxury items) or are irregular for that individual for the year prior to filing for bankruptcy.

Where the pattern of consumption is irregular, objections to the discharge of atypical debt can be filed with a court filing system. In one embodiment, the objection is filed electronically in the court filing system through the network 24 using the system 10. In an exemplary embodiment, a request is transmitted to a selected attorney to file the objection. The objections may be filed either as an agent or assignee of a creditor. For those identified patterns that exceed a predefined threshold (threshold amount of cash advances, threshold amount of luxury items purchases, threshold transaction amount, etc.), the method 32 proceeds to step 44.

In an exemplary embodiment, for each of the plurality of bankruptcy filing information in which the identified pattern of consumption exceeds a predefined threshold, to identify a geographic region associated with the bankruptcy filing information at step 44, the data analysis module 26 analyzes the bankruptcy filing information to determine an appropriate geographic region. In some embodiments, the appropriate geographic region is identified based on address information in the bankruptcy filing. The city, state, and zip code can be analyzed to determine a proper geographic region.

In an exemplary embodiment, to receive information on licensed attorneys from an attorney database wherein the information is associated with the geographic region at step 46, the proper geographic region is communicated to the data collection module 20 via the network 24, and the data collection module 20 accesses, via the network 24, a database that contains attorneys that are locally licensed in the geographic region. The database can also include reviews, biographical information, ratings, and other relevant information that aid in the selection of an attorney. In one embodiment, the attorney is specialized in bankruptcy.

In an exemplary embodiment, to receive a selection of an attorney from the attorney database at step 48, a user of the system 10 reviews the information of locally licensed attorneys in the database, selects an attorney, and inputs the selection into the system 10. The user may draw on other people's knowledge of the attorneys during the decision-making process. For example, the user may ask for a recommendation from a friend or associate who is familiar with attorneys in the geographic region, or ask a local attorney bar association for a referral.

In an exemplary embodiment, to transmit the bankruptcy filing information, the pattern of consumption, credit reporting data, and transactional data to the selected attorney at step 50, the user collects all the information and data from the data collection module 20 and sends the data electronically through the network 24 to the selected attorney. In another embodiment, the information and data are printed out and physically sent to the selected attorney.

Once the locally licensed attorney receives the information and data, he or she can use it to obtain a judicial decree, or enter into an agreement, that a debt is not discharged and can be collected. In one embodiment, the licensed attorney contacts the debtor's attorney. For example, the local attorney can enter into a settlement agreement regarding the repayment of the debt.

The present disclosure describes a method and system that identifies and prevents certain debts incurred with the intent to hinder, delay, or defraud a creditor from being discharged in bankruptcy proceedings. The methods obtain information in real-time and facilitate the identification of irregular or fraudulent patterns of consumption.

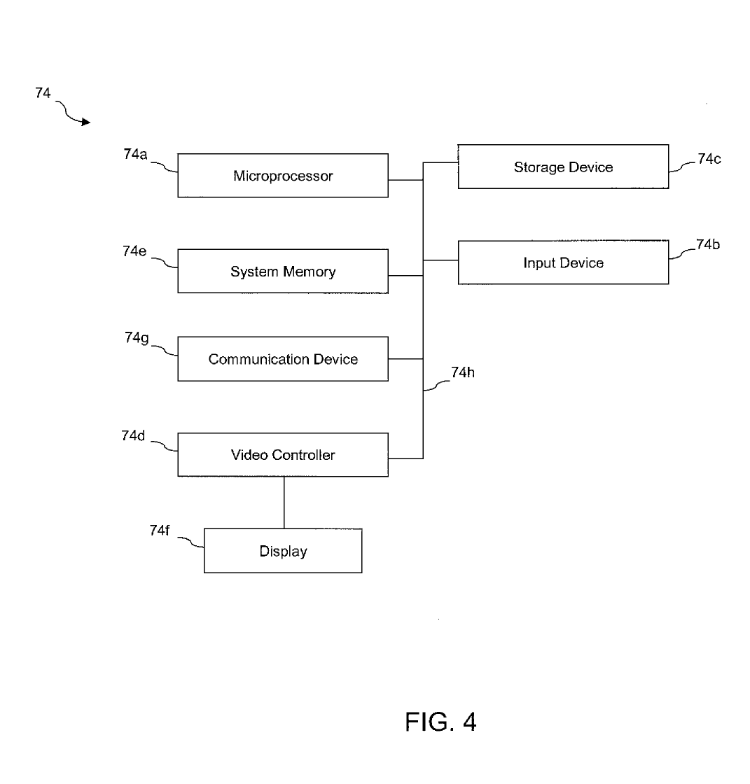

In an exemplary embodiment, as illustrated in FIG. 4 with continuing reference to FIGS. 1-3, an illustrative node 74 for implementing one or more embodiments of one or more of the above-described networks, elements, methods and/or steps, and/or any combination thereof, is depicted. The node 74 includes a microprocessor 74a, an input device 74b, a storage device 74c, a video controller 74d, a system memory 74e, a display 74f, and a communication device 74g all interconnected by one or more buses 74h. In several exemplary embodiments, the storage device 74c may include a floppy drive, hard drive, CD-ROM, optical drive, any other form of storage device and/or any combination thereof. In several exemplary embodiments, the storage device 74c may include, and/or be capable of receiving, a floppy disk, CD-ROM, DVD-ROM, or any other form of computer-readable medium that may contain executable instructions. In several exemplary embodiments, the communication device 74g may include a modem, network card, or any other device to enable the node to communicate with other nodes. In several exemplary embodiments, any node represents a plurality of interconnected (whether by intranet or Internet) computer systems, including without limitation, personal computers, mainframes, PDAs, and cell phones.

In several exemplary embodiments, one or more of the data center 12, the module 20 and the module 26 is, or at least includes, the node 74 and/or components thereof, and/or one or more nodes that are substantially similar to the node 74 and/or components thereof. In several exemplary embodiments, one or more of the above-described components of one or more of the node 74, the data center 12, the module 20, and the module 26, include respective pluralities of same components.

In several exemplary embodiments, a computer system typically includes at least hardware capable of executing machine readable instructions, as well as the software for executing acts (typically machine-readable instructions) that produce a desired result. In several exemplary embodiments, a computer system may include hybrids of hardware and software, as well as computer sub-systems.

In several exemplary embodiments, hardware generally includes at least processor-capable platforms, such as client-machines (also known as personal computers or servers), and hand-held processing devices (such as smart phones, personal digital assistants (PDAs), or personal computing devices (PCDs), for example). In several exemplary embodiments, hardware may include any physical device that is capable of storing machine-readable instructions, such as memory or other data storage devices. In several exemplary embodiments, other forms of hardware include hardware sub-systems, including transfer devices such as modems, modem cards, ports, and port cards, for example.

In several exemplary embodiments, software includes any machine code stored in any memory medium, such as RAM or ROM, and machine code stored on other devices (such as floppy disks, flash memory, or a CD ROM, for example). In several exemplary embodiments, software may include source or object code. In several exemplary embodiments, software encompasses any set of instructions capable of being executed on a node such as, for example, on a client machine or server.

In several exemplary embodiments, combinations of software and hardware could also be used for providing enhanced functionality and performance for certain embodiments of the present disclosure. In an exemplary embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In several exemplary embodiments, computer readable mediums include, for example, passive data storage, such as a random access memory (RAM) as well as semi-permanent data storage such as a compact disk read only memory (CD-ROM). One or more exemplary embodiments of the present disclosure may be embodied in the RAM of a computer to transform a standard computer into a new specific computing machine. In several exemplary embodiments, data structures are defined organizations of data that may enable an embodiment of the present disclosure. In an exemplary embodiment, a data structure may provide an organization of data, or an organization of executable code.

In several exemplary embodiments, the network 24, and/or one or more portions thereof, may be designed to work on any specific architecture. In an exemplary embodiment, one or more portions of the network 24 may be executed on a single computer, local area networks, client-server networks, wide area networks, internets, hand-held and other portable and wireless devices and networks.

In several exemplary embodiments, a database may be any standard or proprietary database software, such as Oracle, Microsoft Access, SyBase, or DBase II, for example. In several exemplary embodiments, the database may have fields, records, data, and other database elements that may be associated through database specific software. In several exemplary embodiments, data may be mapped. In several exemplary embodiments, mapping is the process of associating one data entry with another data entry. In an exemplary embodiment, the data contained in the location of a character file can be mapped to a field in a second table. In several exemplary embodiments, the physical location of the database is not limiting, and the database may be distributed. In an exemplary embodiment, the database may exist remotely from the server, and run on a separate platform. In an exemplary embodiment, the database may be accessible across the Internet. In several exemplary embodiments, more than one database may be implemented.

In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

A method has been described that includes establishing an acceptable threshold monthly income amount, an acceptable threshold monthly expense amount, and an acceptable threshold income amount; receiving, via a computing network, a plurality of bankruptcy filing information from a database having information pertaining to bankruptcy filings; for each of the plurality of bankruptcy filing information, determining if a monthly income amount exceeds the acceptable threshold monthly income amount; determining if a monthly expense amount exceeds the acceptable threshold monthly expense amount; and determining if an income amount exceeds the acceptable threshold income amount; for each of the plurality of bankruptcy filing information in which the monthly income amount, monthly expense amount, or income exceeds the acceptable threshold amount, receiving, via a computer network, credit reporting data and transactional data from a financial network database, wherein the credit reporting data and transactional data is associated with an individual relating to one of the plurality of bankruptcy filing information; analyzing the credit reporting data and transactional data to identify a pattern of consumption for a predefined time period prior to a filing date associated with the one of the plurality of bankruptcy filing information; and for each of the plurality of bankruptcy filing information in which the identified pattern of consumption exceeds a predefined threshold, identifying a geographic region associated with the bankruptcy filing information; receiving information regarding licensed attorneys from an attorney database, wherein the information is associated with the geographic region; receiving a selection of an attorney from the attorney database; and transmitting the bankruptcy filing information, the pattern of consumption, credit reporting data and transactional data to the selected attorney.

A computer readable medium comprising a plurality of instructions stored therein has been described, the plurality of instructions comprising instructions, that when executed, establish an acceptable threshold monthly income amount, an acceptable threshold monthly expense amount, and an acceptable threshold income amount; instructions, that when executed, receive, via a computing network, a plurality of bankruptcy filing information from a database having information pertaining to bankruptcy filings; for each of the plurality of bankruptcy filing information, instructions, that when executed: determine if a monthly income exceeds the acceptable threshold monthly income amount; determine if a monthly expense exceeds the acceptable threshold monthly expense amount; and determine if an income exceeds the acceptable threshold income amount; for each of the plurality of bankruptcy filing information in which the monthly income amount, monthly expense amount, or income exceeds the acceptable threshold amount, instructions, that when executed: receive, via a computer network, credit reporting data and transactional data from a financial network database, wherein the credit reporting data and transactional data is associated with an individual relating to one of the plurality of bankruptcy filing information; analyze the credit reporting data and transactional data to identify a pattern of consumption for a predefined time period prior to a filing date associated with the one of the plurality of bankruptcy filing information; and for each of the plurality of bankruptcy filing information in which the identified pattern of consumption exceeds a predefined threshold, instructions, that when executed: identify a geographic region associated with the bankruptcy filing information; receive information regarding licensed attorneys from an attorney database, wherein the information is associated with the geographic region; receive a selection of an attorney of an attorney from the attorney database, and transmit the bankruptcy filing information, the pattern of consumption, credit reporting data and transactional data to the selected attorney.

A system comprising a node comprising a processor and a computer readable medium operably coupled thereto, the computer readable medium comprising a plurality of instructions stored therein, the plurality of instructions being accessible to, and executable by, the processor has been described, the plurality of instructions comprising instructions, that when executed establish an acceptable threshold monthly income amount, an acceptable threshold monthly expense amount, and an acceptable threshold income amount; instructions, that when executed, receive, via a computing network, a plurality of bankruptcy filing information from a database having information pertaining to bankruptcy filings; for each of the plurality of bankruptcy filing information, instructions, that when executed: determine if a monthly income exceeds the acceptable threshold monthly income amount; determine if a monthly expense exceeds the acceptable threshold monthly expense amount; and determine if an income exceeds the acceptable threshold income amount; for each of the plurality of bankruptcy filing information in which the monthly income amount, monthly expense amount, or income exceeds the acceptable threshold amount, instructions, that when executed: receive, via a computer network, credit reporting data and transactional data from a financial network database, wherein the credit reporting data and transactional data is associated with an individual relating to one of the plurality of bankruptcy filing information; analyze the credit reporting data and transactional data to identify a pattern of consumption for a predefined time period prior to a filing date associated with the one of the plurality of bankruptcy filing information; and for each of the plurality of bankruptcy filing information in which the identified pattern of consumption exceeds a predefined threshold, instructions, that when executed: identify a geographic region associated with the bankruptcy filing information; receive information regarding licensed attorneys from an attorney database, wherein the information is associated with the geographic region; receive a selection of an attorney from the attorney database, and transmit the bankruptcy filing information, the pattern of consumption, credit reporting data and transactional data to the selected attorney.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

1. A method comprising:
establishing, by a processor,
an acceptable threshold monthly income amount according to 11 U.S.C. §101(10A),
an acceptable threshold monthly expense amount according to Schedule J of a bankruptcy petition, and
an acceptable threshold income amount according to Schedule I of the bankruptcy petition;
receiving, via a computer network, a plurality of bankruptcy filing information from a database having information pertaining to bankruptcy filings;
for each of the plurality of bankruptcy filing information,
determining if a monthly income amount exceeds the acceptable threshold monthly income amount;
determining if a monthly expense amount exceeds the acceptable threshold monthly expense amount; and
determining if an income amount exceeds the acceptable threshold income amount;
for each of the plurality of bankruptcy filing information in which the monthly income amount, monthly expense amount, or income exceeds the acceptable threshold amount,
receiving, via the computer network, credit reporting data and transactional data from a financial network database, wherein the credit reporting data and transactional data are associated with an individual relating to one of the plurality of bankruptcy filing information;
analyzing, by the processor, the credit reporting data and transactional data to identify a pattern of consumption for a predefined time period prior to a filing date associated with the one of the plurality of bankruptcy filing information; and
for each of the plurality of bankruptcy filing information in which the identified pattern of consumption exceeds a predefined threshold,
identifying a geographic region associated with the bankruptcy filing information;
receiving information regarding licensed attorneys from an attorney database, wherein the information is associated with the geographic region;
receiving a selection of an attorney from the attorney database; and
transmitting the bankruptcy filing information, the pattern of consumption, credit reporting data and transactional data to the selected attorney.

2. The method of claim 1, wherein the bankruptcy filing information comprises Chapter 13 bankruptcy filings.

3. The method of claim 2, wherein the Chapter 13 bankruptcy filings comprise identifying information of an individual, personal and real property owned by the individual, the individual's creditors, the individual's current monthly income, and the individual's current expenditures.

4. The method of claim 3, wherein the appropriate geographic region is identified based on address information in the bankruptcy filing information.

5. The method of claim 1, wherein the acceptable threshold monthly income is $6000 and the acceptable threshold monthly expense amount or acceptable income amount is $4000.

6. The method of claim 1, further comprising transmitting a request to the selected attorney to file an objection to discharge of atypical debt with a court filing system if the credit reporting data or transactional data shows an irregular pattern of consumption.

7. The method of claim 1, further comprising obtaining a judicial decree or entering into an agreement, by the selected attorney, that the debt is not discharged and can be collected.

8. The method of claim 1, wherein the plurality of bankruptcy filing information from the database having information pertaining to bankruptcy filings is received daily.

9. The method of claim 1, wherein the credit reporting data and transactional data comprises size and timing of purchases and nature of products or services purchased.

10. The method of claim 1, wherein the predefined threshold comprises transactions of $1000 or cash advances of $500.

11. The method of claim 1, wherein the predefined time period is one year.

12. A computer readable medium comprising a plurality of instructions stored therein, the plurality of instructions comprising:
instructions, that when executed, establish acceptable threshold monthly income amount according to 11 U.S.C. §101(10A), an acceptable threshold monthly expense amount according to Schedule J of a bankruptcy petition, and an acceptable threshold income amount according to Schedule I of the bankruptcy petition;
instructions, that when executed, receive, via a computer network, a plurality of bankruptcy filing information from a database having information pertaining to bankruptcy filings;
for each of the plurality of bankruptcy filing information, instructions, that when executed:
determine if a monthly income exceeds the acceptable threshold monthly income amount;
determine if a monthly expense exceeds the acceptable threshold monthly expense amount; and
determine if an income exceeds the acceptable threshold income amount;
for each of the plurality of bankruptcy filing information in which the monthly income amount, monthly expense amount, or income exceeds the acceptable threshold amount, instructions, that when executed:
receive, via a computer network, credit reporting data and transactional data from a financial network database, wherein the credit reporting data and transactional data are associated with an individual relating to one of the plurality of bankruptcy filing information;
analyze the credit reporting data and transactional data to identify a pattern of consumption for a predefined time period prior to a filing date associated with the one of the plurality of bankruptcy filing information; and
for each of the plurality of bankruptcy filing information in which the identified pattern of consumption exceeds a predefined threshold, instructions, that when executed:
identify a geographic region associated with the bankruptcy filing information;
receive information regarding licensed attorneys from an attorney database, wherein the information is associated with the geographic region;
receive a selection of an attorney from the attorney database; and
transmit the bankruptcy filing information, the pattern of consumption, credit reporting data and transactional data to the selected attorney.

13. The computer readable medium of claim 12, wherein the bankruptcy filing information comprises Chapter 13 bankruptcy filings.

14. The computer readable medium of claim 12, further comprising instructions, that when executed, file an objection to discharge of a typical debt with a court filing system if the credit reporting data or transactional data shows an irregular pattern of consumption.

15. The computer readable medium of claim 12, wherein the instructions, that when executed, receive a plurality of bankruptcy filing information comprises instructions to receive the filing information daily.

16. The computer readable medium of claim 12, wherein the credit reporting data and transactional data comprises size and timing of purchases and nature of products or services purchased.

17. A system comprising:
a node comprising a processor and computer readable medium operably coupled thereto, the computer readable medium comprising a plurality of instructions stored therein, the plurality of instructions being accessible to, and executable by, the processor, the plurality of instructions comprising:
instructions, that when executed, establish an acceptable threshold monthly income amount according to 11 U.S.C. §101(10A), an acceptable threshold monthly expense amount according to Schedule J of a bankruptcy petition, and an acceptable threshold income amount according to Schedule I of the bankruptcy petition;
instructions, that when executed, receive, via a computer network, a plurality of bankruptcy filing information from a database having information pertaining to bankruptcy filings;
for each of the plurality of bankruptcy filing information, instructions, that when executed:
determine if a monthly income exceeds the acceptable threshold monthly income amount;
determine if a monthly expense exceeds the acceptable threshold monthly expense amount; and
determine if an income exceeds the acceptable threshold income amount;
for each of the plurality of bankruptcy filing information in which the monthly income amount, monthly expense amount, or income exceeds the acceptable threshold amount, instructions, that when executed:
receive, via a computer network, credit reporting data and transactional data from a financial network database, wherein the credit reporting data and transactional data are associated with an individual relating to one of the plurality of bankruptcy filing information;
analyze the credit reporting data and transactional data to identify a pattern of consumption for a predefined time period prior to the filing date associated with the one of the plurality of bankruptcy filing information; and
for each of the plurality of bankruptcy filing information in which the identified pattern of consumption exceeds a predefined threshold, instructions, that when executed:
identify a geographic region associated with the bankruptcy filing information;
receive information regarding licensed attorneys from an attorney database, wherein the information is associated with the geographic region;
receive a selection of an attorney from the attorney database; and
transmit the bankruptcy filing information, the pattern of consumption, credit reporting data and transactional data to the selected attorney.

18. The system of claim 17, wherein the bankruptcy filing information comprises Chapter 13 bankruptcy filings.

19. The system of claim 17, wherein the instructions, when executed, receive a plurality of bankruptcy filing information comprises instructions to receive the filing information daily.

20. The system of claim 17, wherein the credit reporting data and transactional data comprises size and timing of purchases and nature of products or services purchased.
